(19) United States
(12) Patent Application Publication
(10) Pub. No.: US 2025/0124431 A1
(43) Pub. Date: Apr. 17, 2025

(54) METHOD AND SYSTEM FOR CONDITIONALLY TRACING ANONYMOUS TRANSACTION BASED ON SECRET SHARING

(71) Applicant: GUIZHOU UNIVERSITY OF FINANCE AND ECONOMICS, Guiyang (CN)

(72) Inventors: Hai LIU, Guiyang (CN); Fangqiong LI, Guiyang (CN); Hongfa DING, Guiyang (CN); Mingsen DENG, Guiyang (CN); Heling JIANG, Guiyang (CN)

(73) Assignee: GUIZHOU UNIVERSITY OF FINANCE AND ECONOMICS, Guiyang (CN)

(21) Appl. No.: 18/395,665

(22) Filed: Dec. 25, 2023

(30) Foreign Application Priority Data
Oct. 13, 2023 (CN) 202311328341.7

(51) Int. Cl. G06Q 20/38

(52) U.S. Cl. CPC G06Q 20/383; G06Q 20/382

(57) ABSTRACT

A system for conditionally tracing an anonymous transaction is provided, and cryptography technology is used to add tags to transaction-related information, and relies on implicit tags to achieve transaction traceability. In addition, based on the secret sharing idea, the information of reconstructed users' real transactions is divided, and differentiated information reconstruction methods are used to reduce the probability of collusion attacks, prevent the full scope of supervision without restriction, and reduce the traceability cost.

### CROSS REFERENCE TO THE RELATED APPLICATIONS

This application is based upon and claims priority to Chinese Patent Application No. 202311328341.7, filed on Oct. 13, 2023, the entire contents of which are incorporated herein by reference.

### TECHNICAL FIELD

The present disclosure belongs to the technical field of blockchain transactions, and in particular relates to a method and system for conditionally tracing an anonymous transaction based on secret sharing.

### BACKGROUND

As a decentralized distributed ledger technology, blockchain technology has been widely used in the financial field because of its unique characteristics such as multiparty consensus, traceability, and data encryption, each highly coupled with business characteristics of the financial field. At present, development of blockchain technology in China has gradually risen to a national strategic level. However, global disclosure of transaction information of a blockchain makes privacy security of the blockchain seriously questionable. The blockchain provides a pseudonym to protect identity privacy of a participant such that a transaction address is not directly associated with identity information of the participant. However, a large quantity of studies have shown that an attacker can still associate a specific transaction address with the identity of a participant by acquiring and analyzing a transaction flow and other related information, to overcome identity privacy and transaction privacy of the participant.

Revelation of pseudo-anonymity of blockchain transactions has led to extensive research on an anonymous transaction idea. An anonymous transaction technology can protect identity privacy and transaction privacy of users. However, strong anonymity protects the transaction privacy but destroys transaction traceability. The lack of transaction traceability facilitates money laundering and smuggling of lawbreakers. Therefore, there is a trade-off between transaction traceability and transaction anonymity. Excessively strong transaction anonymity makes it difficult for regulatory authorities to trace and monitor transactions. Consequently, the regulatory authorities lose control and supervision of a financial system, risks of economic crimes are increased, and social harmony and stability are affected. However, complete removal of transaction anonymity leads to leakage of personal privacy information and endangers personal and property safety of citizens. Therefore, an appropriate supervision framework and technical solution are needed to strike a balance between transaction traceability and transaction anonymity.

However, most of existing anonymous transaction supervision schemes are implemented based on cryptocurrencies. Cryptocurrencies using a complex cryptography technology are not suitable for high-frequency transaction scenarios in real life. A decentralized coin mixing scheme has irreplaceable advantages in the anonymous transaction technology due to there being no need for participation of a third party and no use of a complex cryptography technology. However, there is a lack of in-depth research on a supervision model based on a decentralized coin mixing structure.

Through the foregoing analysis, the prior art has the following problems and defects:
(1) Most of the existing anonymous transaction supervision schemes are implemented based on cryptocurrencies. Cryptocurrencies using a complex cryptography technology are not suitable for high-frequency transaction scenarios in real life.
(2) The decentralized coin mixing scheme has irreplaceable advantages in the anonymous transaction technology due to there being no need for participation of a third party and no use of a complex cryptography technology. However, there is no perfect supervision model based on the decentralized coin mixing structure.
(3) Existing anonymous transaction schemes cannot balance transaction anonymity and transaction traceability. There are two extremes: strong anonymity and weak traceability; and weak anonymity and strong traceability.

### SUMMARY

In view of the problems in the prior art, the present disclosure provides a method and system for conditionally tracing an anonymous transaction based on secret sharing.

The present disclosure is implemented as follows. A method for conditionally tracing an anonymous transaction based on secret sharing is provided. The method for conditionally tracing an anonymous transaction based on secret sharing includes the following steps:
S101: introducing a message platform and a supervisor based on a typical decentralized coin mixing structure to design a system model for conditionally tracing an anonymous transaction;
S102: dividing, based on a threshold secret sharing idea, information required to reconstruct a real transaction of a user, to increase secret reconstruction difficulty for an ordinary user and reduce a secret reconstruction overhead for the supervisor;
S103: conducting an anonymous transaction between a transaction initiator and a transaction recipient; and
S104: conditionally tracing, by the supervisor, the anonymous transaction through an anonymous-transaction conditional tracing scheme CIS during auditing.

Further, the message platform and the supervisor are introduced into the system model in S101.

Further, the threshold secret sharing scheme in S102 mainly includes two phases: secret distribution and secret reconstruction.

Further, in S102, each user is unique, and the message platform is capable of verifying identity information of the user.

Further, the anonymous-transaction conditional tracing scheme CTS provides two different tracing schemes: a transaction tracing scheme and a fund tracing scheme.

Further, the transaction tracing scheme allows the supervisor to obtain identity information of an actual initiator and an actual recipient of any transaction to trace a single transaction; and the fund tracing scheme allows the supervisor to de-anonymize all anonymous transactions initiated by a target user, to determine a fund transfer path of the target user.

Another objective of the present disclosure is to provide a system for conditionally tracing an anonymous transaction based on secret sharing, implementing the method for conditionally tracing an anonymous transaction based on secret sharing and including:
a system model establishment module configured to introduce a message platform and a supervisor to design a system model;
a secret sharing module connected to the system model establishment module, an anonymous transaction module, and a transaction tracing module, and configured to reconstruct information about a real transaction of a user to enhance privacy of an ordinary user and reduce secret reconstruction difficulty for the supervisor;
the anonymous transaction module connected to the system model establishment module, the secret sharing module, and the transaction tracing module, and configured to conduct an anonymous transaction between a transaction initiator and a transaction recipient; and
the transaction tracing module connected to the system model establishment module, the secret sharing module, and the anonymous transaction module, and configured to trace an anonymous transaction, including transaction tracing and fund tracing.

Another objective of the present disclosure is to provide a computer device. The computer device includes a memory and a processor. The memory stores a computer program. The computer program, when executed by the processor, enables the processor to perform steps of the method for conditionally tracing an anonymous transaction based on secret sharing.

Another objective of the present disclosure is to provide a computer-readable storage medium, storing a computer program. The computer program, when executed by a processor, enables the processor to perform steps of the method for conditionally tracing an anonymous transaction based on secret sharing.

Another objective of the present disclosure is to provide an information data processing terminal. The information data processing terminal is configured to implement the system for conditionally tracing an anonymous transaction based on secret sharing.

In combination with the foregoing technical solutions and the technical problems to be resolved, the present disclosure has the following advantages and positive effects:

Firstly, in the present disclosure, the method and system for conditionally tracing an anonymous transaction based on secret sharing are provided based on the decentralized coin mixing structure. In the present disclosure, the threshold secret sharing idea is used to divide the information required to reconstruct the real transaction of the user, to increase the secret reconstruction difficulty for the ordinary user and reduce the secret reconstruction overhead for the supervisor. This reduces a probability of collusion attacks and prevents unrestricted full-range supervision of regulatory authorities.

The present disclosure provides two transaction tracing schemes for regulatory authorities. The tracing schemes can help the regulatory authorities trace anonymous transactions under conditions of grasping different information. The present disclosure can give consideration to both transaction anonymity and transaction traceability. Regulatory auditing of government departments are facilitated while user privacy protection requirements are met.

Secondly, in the present disclosure, a scheme for conditionally tracing an anonymous transaction based on secret sharing is designed based on the typical decentralized coin mixing structure. In the scheme, two entities, namely the message platform and the supervisor, are introduced based on the decentralized coin mixing structure to design the system model for conditionally tracing an anonymous transaction. To prevent privacy leakage of legitimate users due to global supervision of the regulatory authorities during transaction tracing, the present disclosure uses a threshold secret sharing technology to divide the information required to reconstruct an actual transaction of a user. The message platform, the supervisor, and the transaction mixer each hold an information fragment. The actual transaction of the user can be reconstructed only if all transaction mixers in the anonymous set collude. This greatly reduces the probability of collusion attacks and effectively maintains anonymity of user transactions. In addition, the supervisor only needs to collaborate with the message platform and the key transaction mixer in the anonymous set to de-anonymize the transaction. This can prevent unrestricted full-range supervision and protect transaction privacy of legitimate users while effectively reducing supervision overheads.

The anonymous-transaction conditional tracing scheme designed in the present disclosure provides two transaction tracing schemes: the transaction tracing scheme and the fund tracing scheme. The transaction tracing scheme allows the regulatory authorities to obtain the identity information of the actual initiator and the actual recipient of any transaction to trace a single transaction. The fund tracing scheme allows the regulatory authorities to de-anonymize all anonymous transactions initiated by the target user, to determine the fund transfer path of the target user. These two schemes can help the regulatory authorities trace anonymous transactions under conditions of grasping different information, and control a tracing scope within a scope required for law enforcement to protect privacy security of legitimate users.

Thirdly, auxiliary evidence for inventiveness of the present disclosure is further reflected in important aspects as follows:

(1) The Expected Profits and Commercial Value of the Present Disclosure after Transformation are as Follow:

A blockchain technology has been widely used in the financial field due to its unique characteristics such as multiparty consensus, traceability, and data encryption. Development of the blockchain technology in China has gradually risen to a national strategic level. However, global disclosure of transaction information of a blockchain makes privacy security of the blockchain seriously questioned. In the face of the blockchain technology, which is a double-edged sword, China has promulgated laws and regulations such as Cybersecurity Law, Data Security Law, Guiding Opinions on Promoting Blockchain Technology and Industrial Innovation and Development, Cryptography Law of the People's Republic of China, and Internet Information Service Management Measures to promote and standardize the development of the blockchain technology. The regulations emphasize that the development and application of the blockchain technology need to meet compliance requirements of the national network security field, and standardize processing of personal information and sensitive data. It can be learned that ensuring security is a key factor for breaking through a development bottleneck of the blockchain technology. The present disclosure meets a regulatory auditing requirement of the regulatory authorities while maintaining anonymity of user transactions, can be widely applied to the blockchain+financial field, has great positive impact on promoting the application of the blockchain technology and development of the financial industry, and has high expected profits and commercial value.

### (2) The Present Disclosure Fills the Technical Gap in the Industry Throughout the World:

The present disclosure fills a gap of research on a supervision model based on the decentralized coin mixing structure in the field of anonymous transaction research around the world, breaks through defects and deficiencies of a decentralized coin mixing scheme, and provides an effective solution for supervising anonymous transactions. In the present disclosure, the system model for conditionally tracing an anonymous transaction is first designed based on the typical decentralized coin mixing structure. The two transaction tracing schemes are proposed based on the model. The two transaction tracing schemes can allow the regulatory authorities to trace anonymous transactions under conditions of grasping different information, and control the tracing scope within the scope required for law enforcement to protect privacy security of legitimate users. In addition, the present disclosure uses the threshold secret sharing technology to increase difficulty for an ordinary user to reconstruct actual transaction information of a user and reduce supervision overheads of the regulatory authorities, to improve security and practicability of the scheme. The present disclosure can implement supervision and tracing of illegal users and illegal funds while maintaining transaction anonymity of legitimate users.

(3) The Present Disclosure Resolves the Technical Problems that People have been Eager to Resolve but have not been Successfully Resolved:

Revelation of pseudo-anonymity of a blockchain makes an anonymous transaction idea widely studied and applied in academia. People's increasing sensitivity to transaction information also makes an anonymous transaction technology gradually applied in real life. However, most of existing anonymous transaction schemes strive to pursue transaction anonymity, ignoring work difficulty brought by strong anonymity to regulatory authorities. Unsupervised transactions provide opportunities for lawbreakers, threatening social harmony and stability. However, excessively strong transaction traceability increases work pressure of the regulatory authorities and violates transaction privacy of legitimate users. Therefore, in view of the problem that the existing schemes cannot balance transaction anonymity and transaction traceability, the present disclosure proposes the scheme for conditionally tracing an anonymous transaction based on secret sharing. In the present disclosure, the system model for conditionally tracing an anonymous transaction is first designed based on the typical decentralized coin mixing structure. The two transaction tracing schemes are proposed based on the model. The transaction tracing schemes provided in the present disclosure can allow the regulatory authorities to trace anonymous transactions under conditions of grasping different information, and control the tracing scope within the scope required for law enforcement to protect privacy security of legitimate users. Therefore, the present disclosure can implement controllable anonymity of anonymous transactions while maintaining transaction anonymity. A transaction anonymity requirement of users and the regulatory auditing requirement of the regulatory authorities both can be met.

### (4) The Present Disclosure Overcomes the Following Technical Prejudice:

Current technical solutions either pursue transaction anonymity and ignore practical needs for transaction traceability; or pursue transaction traceability and ignore users' requirements for transaction anonymity. Therefore, the present disclosure uses the threshold secret sharing technology to divide information containing an actual transaction of a user. This prevents unrestricted full-range supervision of the regulatory authorities and protects transaction privacy of legitimate users while implementing transaction anonymity. In addition, different secret reconstruction manners increase the secret reconstruction difficulty for the ordinary user and reduce the overheads of the regulatory authorities, to improve security and practicability of the scheme. Further, the two transaction tracing schemes provided in the present disclosure can not only allow the regulatory authorities to obtain the identity information of the actual initiator and the actual recipient of any transaction to trace a single transaction, but also allow the regulatory authorities to de-anonymize all anonymous transactions initiated by the target user, to determine the fund transfer path of the target user. The two transaction tracing schemes can help the regulatory authorities trace anonymous transactions under conditions of grasping different information, and control the tracing scope within the scope required for law enforcement to protect privacy security of legitimate users.

Fourthly, the method for conditionally tracing an anonymous transaction based on secret sharing provides a solution for resolving a supervision problem in anonymous transactions. The following explains a significant technological advance achieved in each step:
S101: The message platform and the supervisor are introduced based on the typical decentralized coin mixing structure to design the system model for conditionally tracing an anonymous transaction. This is an important technological advance because it allows transaction tracing while protecting user privacy, to balance privacy protection and a supervision requirement.
S102: The threshold secret sharing scheme is constructed by using the threshold secret sharing idea. This scheme divides the information required to reconstruct the real transaction of the user, to increase the secret reconstruction difficulty for the ordinary user and reduce the secret reconstruction overhead for the supervisor. This is a significant technological advance because it ensures that the real transaction of the user can be reconstructed only if a specific condition is met (for example, a specific quantity of holders agree), to improve transaction security.
S103: The anonymous transaction is conducted between the transaction initiator and the transaction recipient. This is a technological advance because it implements transaction anonymity and protects user identity privacy and transaction privacy.
S104: The supervisor traces the anonymous transaction through the anonymous-transaction conditional tracing scheme during auditing. This is a significant technological advance because it allows the supervisor to trace anonymous transactions when necessary. This enhances a transaction supervision capability and improves security and reliability of the system.

In general, the method for conditionally tracing an anonymous transaction based on secret sharing implements effective tracing of anonymous transactions while protecting user privacy. This is an important advance in the anonymous transaction technology.

### BRIEF DESCRIPTION OF THE DRAWINGS

FIG. 1 is a flowchart of a method for conditionally tracing an anonymous transaction based on secret sharing according to an embodiment of the present disclosure;

FIG. 2 shows a system model for conditionally tracing an anonymous transaction according to an embodiment of the present disclosure;

FIG. 3A is a diagram of an anonymous transaction process according to an embodiment of the present disclosure, and FIGS. 3B-3D show the B1, B2, and B3 in FIG. 3A, respectively;

FIGS. 4A-4D show a sample anonymous transaction and views of different tracing schemes according to an embodiment of the present disclosure, where FIG. 4A shows a transaction process, FIG. 4B is a view without supervision, FIG. 4C is a view of a transaction tracing scheme, and FIG. 4D is a view of a fund tracing scheme;

FIG. 5 is a structural diagram of a system for conditionally tracing an anonymous transaction based on secret sharing according to an embodiment of the present disclosure;

FIG. 6 shows an average computation delay required for transaction tracing according to an embodiment of the present disclosure;

FIG. 7 shows an average communication overhead required for transaction tracing according to an embodiment of the present disclosure;

FIG. 8 shows impact of a historical transaction volume on an average computation delay required for transaction tracing according to an embodiment of the present disclosure;

FIG. 9 shows impact of a historical transaction volume on an average communication overhead required for transaction tracing according to an embodiment of the present disclosure;

FIG. 10 shows an average computation delay required for fund tracing according to an embodiment of the present disclosure;

FIG. 11 shows an average communication overhead required for fund tracing according to an embodiment of the present disclosure;

FIG. 12 shows impact of a historical transaction volume on an average computation delay required for fund tracing according to an embodiment of the present disclosure; and

FIG. 13 shows impact of a historical transaction volume on an average communication overhead required for fund tracing according to an embodiment of the present disclosure.

Reference numerals: 1: user; 2: transaction; 3: target user; 4: key user; 5: actual transaction.

### DETAILED DESCRIPTION OF THE EMBODIMENTS

To make the objectives, technical solutions, and advantages of the present disclosure clearer and more comprehensible, the present disclosure will be further described below in detail in conjunction with embodiments. It should be understood that the embodiments described herein are merely intended to explain but not to limit the present disclosure.

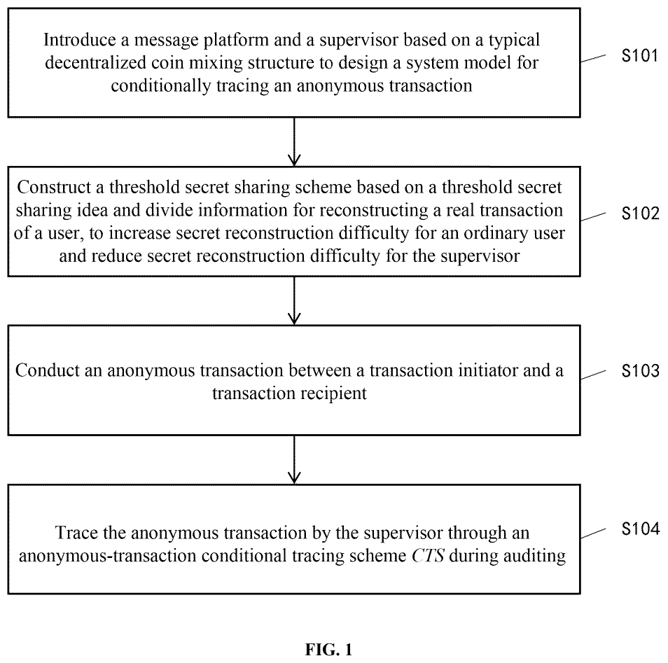

As shown in FIG. 1, a method for conditionally tracing an anonymous transaction based on secret sharing includes the following steps:
S101: A message platform and a supervisor are introduced based on a typical decentralized coin mixing structure to design a system model for conditionally tracing an anonymous transaction.
S102: A threshold secret sharing scheme is constructed based on a threshold secret sharing idea and information required to reconstruct a real transaction of a user is divided to increase secret reconstruction difficulty for an ordinary user and reduce a secret reconstruction overhead for the supervisor.
S103: An anonymous transaction is conducted between a transaction initiator and a transaction recipient.
S104: The anonymous transaction is traced by the supervisor through an anonymous-transaction conditional tracing scheme CIS during auditing.

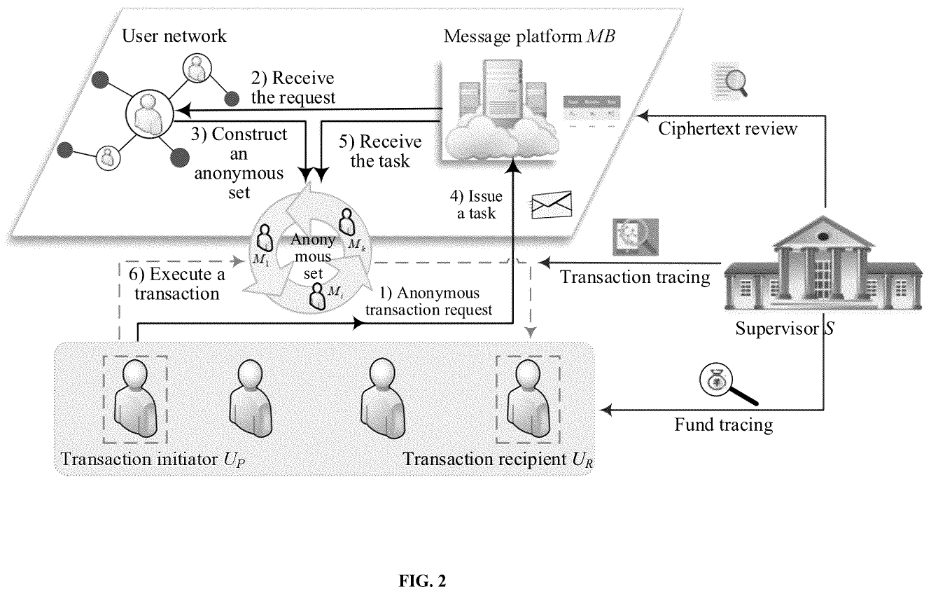

FIG. 2 shows the system model in S101. Two entities, namely the message platform MB and the supervisor S, are introduced to design the system model for conditionally tracing an anonymous transaction. The model consists of five entities: the transaction initiator U_{P}, a transaction mixer Mᵢ, the transaction recipient U_{R}, the message platform MB, and the supervisor S.

In a decentralized coin mixing idea, there is no direct transaction between the transaction initiator U_{P} and the transaction recipient U_{R}, but an anonymous set M_{Set} composed of transaction mixers Mᵢ is inserted between U_{P} and U_{R}. Introduction of the anonymous set M_{Set} transforms an actual transaction

$$T ( {U}_{P} {⟶}^{m} {U}_{R} )$$

the user U_{P} into

$$T ( {U}_{P} {⟶}^{m} {U}_{R} ) ⇒ \qquad {T}_{0} ( {U}_{P} {⟶}^{m} {M}_{S e t} ) ⊕ {T}_{1} ( {M}_{S e t} {⟶}^{m} {U}_{R} ) ,$$

to disturb a mapping relationship between the transaction initiator U_{P} and the transaction recipient U_{R} and implement transaction anonymity.

$${T}_{0} ( {U}_{P} {⟶}^{m} {M}_{S e t} )$$

is used to cut off a direct transaction association between the transaction initiator U_{P} and the transaction recipient U_{R}.

$${T}_{1} ( {M}_{S e t} {⟶}^{m} {U}_{R} )$$

is used to ensure that funds can be transferred to the correct transaction recipient U_{R}.

A set of all users in a network is U={P₀, P₁, P₂, . . . , Pₙ}. U_{P}_{₀} is the transaction initiator. When the transaction initiator needs to conduct a transaction with the user U_{P}_{₁}, to protect privacy information of the transaction initiator from being leaked in a transaction process, the transaction initiator first broadcasts an anonymous transaction request Q_{P}_{₀} to the other users U′={P₂, P₃, . . . , Pₙ} in the network through the message platform MB and selects k users from all users who accept the request, to construct the anonymous set M_{Set}={M₁, . . . , Mᵢ, . . . , Mₖ}. k represents a privacy requirement of the user U_{P}_{₀}. After the anonymous set Mₛₑₜ is generated, the user U_{P}_{₀} may divide the actual transaction as follows:

$$T ( {U}_{{P}_{0}} {⟶}^{m} {U}_{{R}_{1}} ) ⇒ {t}_{0} ( {U}_{{P}_{0}} {⟶}^{m} {M}_{1} ) ⊕ {t}_{1} ( {M}_{1} {⟶}^{m} {M}_{2} ) ⊕ … ⊕ {t}_{k - 1} ( {M}_{k - 1} {⟶}^{m} {M}_{k} ) ⊕ {t}_{k} ( {M}_{k} {⟶}^{m} {U}_{{R}_{1}} ) ;$$

and sends, to the transaction mixer Mᵢ in the anonymous set through the message platform MB, a task ciphertext

$${W}_{{P}_{0}}^{{M}_{i}}$$

obtained by encrypting information about the sub-transaction

$${t}_{i} ( {M}_{i} {⟶}^{m} {M}_{i + 1} )$$

by using a public key of the transaction mixer. m is an actual transaction amount. After receiving the task ciphertext

$${W}_{{P}_{0}}^{{M}_{i}} ,$$

the transaction

$$T ( {U}_{{P}_{0}} {⟶}^{m} {U}_{{R}_{1}} )$$

mixer Mᵢ decrypts the task ciphertext and verifies signature information; and if the signature information passes the verification, executes the sub-transaction

$${t}_{i} ( {M}_{i} {⟶}^{m} {M}_{i + 1} )$$

based on task content. As an information forwarding platform, the message platform MB does not directly participate in anonymous transactions, but only stores and maintains key information used for transaction tracing and receives and transmits information. The supervisor S does not participate in anonymous transactions and does not have any information about anonymous transactions. The supervisor intervenes in an anonymous transaction only if auditing is needed, to de-anonymize the transaction and trace a flow of funds of a target user.

The threshold secret sharing scheme in S102 mainly includes two phases: secret distribution and secret reconstruction. A distributor in the threshold secret sharing scheme (t,k) first decomposes a secret into k sub-secrets and respectively sends the sub-secrets to k participants. Each participant holds only one sub-secret. A core of the threshold secret sharing scheme (t,k) is that the secret can be reconstructed only if there are at least k sub-secrets. The secret cannot be restored if there are less than k sub-secrets.

In the present disclosure, the transaction

$$T ( {U}_{{P}_{0}} {\to }^{m} {U}_{{R}_{1}} )$$

of the user U_{P}_{₀} is regarded as a secret. The supervisor S, the message platform MB, and the transaction mixers Mᵢ in the anonymous set are regarded as a group of sub-secret holders C={S, MB, M₁, . . . , M₂, . . . , Mₖ}.
(1) Secret distribution phase: The user U_{P} executes a secret division algorithm

$$Gen ( T ( {U}_{{P}_{0}} {\to }^{m} {U}_{{R}_{1}} ) )$$

to divide the secret

$$T ( {U}_{{P}_{0}} {\to }^{m} {U}_{{R}_{1}} )$$

into k+2 sub-secrets as follows:

$$Gen ( T ( {U}_{{P}_{0}} {\to }^{m} {U}_{{R}_{1}} ) ) ⇒ \{ {s}_{1} , {s}_{2} , … , {s}_{i} , … , {s}_{k} , {s}_{k + 2} \} ;$$

and then sends the sub-secret s₁ to the supervisor S, the sub-secret s₂ to the message platform MB, and the sub-secret sᵢ₊₂ to the transaction mixer Mᵢ in the anonymous set. The sub-secret s₁ is a private key of the supervisor S. The supervisor can decrypt an anonymous transaction identifier generated in an anonymous transaction process and a tag marking the key transaction mixer Mₖ. The sub-secret s₂ is a private key of and the information stored and maintained by the message platform MB. The sub-secret sᵢ₊₂ is the task ciphertext

$${W}_{{P}_{0}}^{{M}_{i}}$$

received by and a private key of the transaction mixer Mᵢ.
(2) It can be learned based on the secret and the secret division manner that there are two methods for secret reconstruction.
1) Only the transaction mixers Mᵢ participate in secret reconstruction: Because each transaction mixer Mᵢ has information about only one link of the anonymous transaction, the complete anonymous transaction process

$${t}_{0} ( {U}_{{P}_{0}} {\to }^{m} {M}_{1} ) ⊕ {t}_{1} ( {M}_{1} {\to }^{m} {M}_{2} ) ⊕ … ⊕ {t}_{k - 1} ( {M}_{k - 1} {\to }^{m} {M}_{k} ) ⊕ {t}_{k} ( {M}_{k} {\to }^{m} {U}_{{R}_{1}} )$$

can be restored only by piecing together the information about the sub-transactions

$${t}_{i} ( {M}_{i} {\to }^{m} {M}_{i + 1} )$$

of the k transaction mixers in the anonymous set Mₛₑₜ, to obtain information about the actual transaction

$$T ( {U}_{{P}_{0}} {\to }^{m} {U}_{{R}_{1}} ) .$$

Therefore, if only the transaction mixers Mᵢ participate in secret reconstruction, t=k sub-secrets

$${W}_{{P}_{0}}^{{M}_{i}}$$

are needed to reconstruct the secret

$$T ( {U}_{{P}_{0}} {\to }^{m} {U}_{{R}_{1}} ) .$$

That is, C¹={M₁, . . . , Mᵢ, . . . , Mₖ} executes a secret reconstruction algorithm

$$Rec ( {s}_{3} , … , {s}_{i} , … , {s}_{k} , {s}_{k + 2} ) ⇒ T ( {U}_{{P}_{0}} {\to }^{m} {U}_{{R}_{1}} ) .$$

2) The supervisor S participates in secret reconstruction: The supervisor S can decrypt the anonymous transaction identifier and the tag marking the key transaction mixer Mₖ to obtain the transaction amount m and identity information of the actual transaction initiator U_{P}_{₀} and the key transaction mixer Mₖ. However, because a mark relationship among the anonymous transaction identifier, the tag marking the key transaction mixer Mₖ, and the task ciphertext is stored in an information table maintained by the message platform MB, a private key decryption information table of the message platform MB needs to be obtained first. In addition, identity information of the actual transaction recipient U_{P}_{₁} exists only in the task ciphertext

$${W}_{{P}_{0}}^{{M}_{k}}$$

received by the key transaction mixer Mₖ. Therefore, the supervisor S needs to obtain a private key of the key transaction mixer Mₖ. After successfully decrypting the task ciphertext

$${W}_{{P}_{0}}^{{M}_{k}}$$

received by Mₖ, the supervisor S can obtain the identity information of the actual recipient U_{R}_{₁} of the anonymous transaction, to restore the actual transaction

$$T ( {U}_{{P}_{0}} {\to }^{m} {U}_{{R}_{1}} ) .$$

Therefore, if the supervisor S participates in secret reconstruction, only the supervisor S, the message platform MB, and the key transaction mixer Mₖ need to provide the sub-secrets to restore the secret

$$T ( {U}_{{P}_{0}} {\to }^{m} {U}_{{R}_{1}} ) .$$

That is, C²={S,MB,Mₖ} executes a secret reconstruction algorithm

$$Rec ( {s}_{1} , {s}_{2} , {s}_{k + 2} ) ⇒ T ( {{U}_{{P}_{0}} \to {U}_{{R}_{1}}}^{m} ) .$$

The threshold secret sharing scheme (t,k) ensures that the actual transaction information of the user can be obtained only if t=k transaction mixers Mᵢ collude. This greatly reduces a probability of collusion attacks and effectively maintains transaction anonymity. In addition, the supervisor S only needs to collaborate with the message platform MB and the key transaction mixer Mₖ in the anonymous set to de-anonymize the transaction. This can prevent unrestricted full-range supervision and protect transaction privacy of legitimate users while effectively reducing supervision overheads.

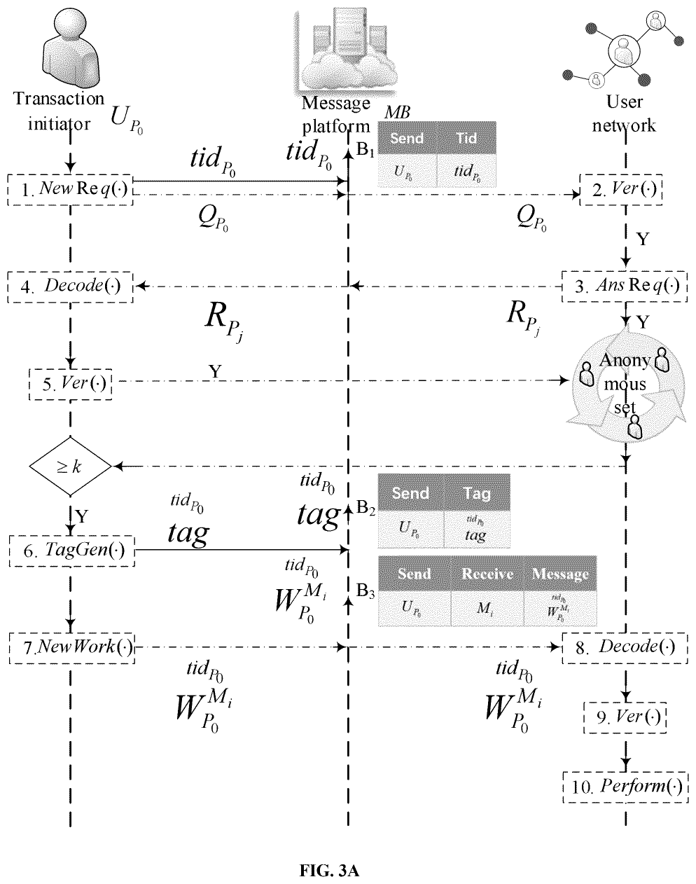

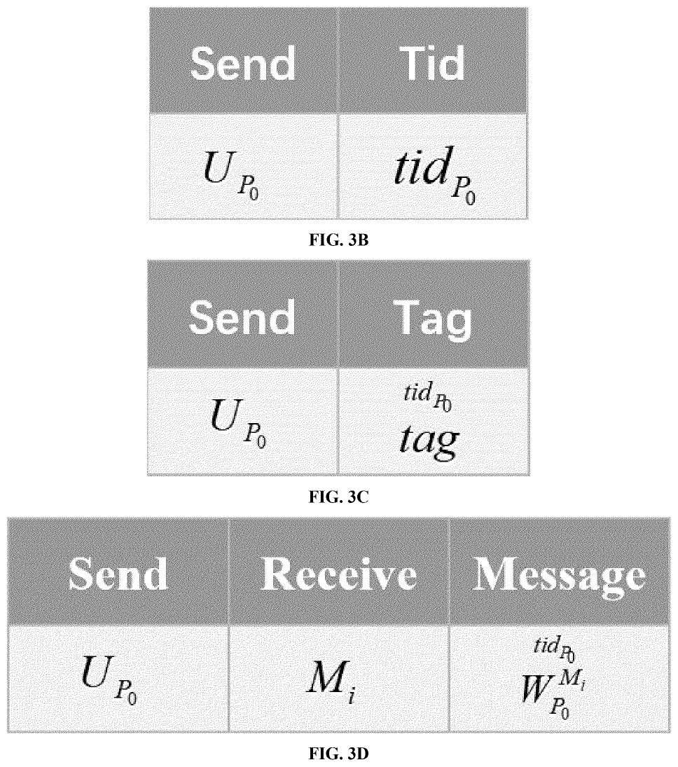

In S103, each user U={P₀, P₁, P₂, . . . , Pₙ} is unique, and the message platform MB is capable of verifying identity information of the user. FIG. 3A shows the anonymous transaction process in the present disclosure.
Step 1: Before conducting the transaction with the transaction recipient U_{R}, the transaction initiator U_{P}_{₀} calls New Req(⋅) to generate the anonymous transaction request Q_{P}_{₁} as follows

$$New Re q ( {U}_{{P}_{0}} , m , tmp , {PK}_{s} , {SK}_{{P}_{0}} ) ⇒ \{ \begin{matrix}Encrypt {( {U}_{{P}_{0}} , m , tmp )}_{{PK}_{S}} \to {tid}_{{P}_{0}} \\ Signature {( {tid}_{{P}_{0}} )}_{{SK}_{{P}_{0}}} \to {Sign}_{{P}_{0}} ( {tid}_{{P}_{0}} )\end{matrix} \} ⇒ {Q}_{{P}_{0}} ;$$

and broadcasts the anonymous transaction request Q_{P}_{₀}={tid_{P}_{₀}, Sign_{P}_{₀}, (tid_{P}_{₀})} to the other users U′={P₂, P₃, . . . , Pₙ} in the network through the message platform MB. PKₛ is a public key of the supervisor S. SK_{P}_{₀} is a private key of the user U_{P}_{₀}. tid_{P}_{₀} is an anonymous transaction identifier obtained after the user U_{P} uses the public key PKₛ of the supervisor S to encrypt the identity information of the user, the transaction amount m, and a timestamp tmp of initiating the anonymous transaction request and is used to uniquely identify the anonymous transaction. Sign(⋅) is a secure signature function, namely an elliptic curve digital signature algorithm (ECDSA). Sign_{P}_{₀}(tid_{P}_{₀}) indicates that the user U_{R} signs the anonymous transaction identifier by using the private key SK_{P}_{₀} of the user. At this time, the message platform MB stores the anonymous transaction identifier tid_{P}_{₀} and updates an information table B₁(Send [symbol] U_{P}_{₀}, Tid [symbol] tid_{P}_{₀}).
Step 2: After receiving the anonymous transaction request Q_{P}_{₀}={tid_{P}_{₀}, Sign_{P}_{₀}, (tid_{P}_{₀})} broadcast by the user U_{P}_{₀}, the other users U′={P₂, P₃, . . . , Pₙ} in the network verify correctness of the signature information Sign_{P}_{₀}(tid_{P}_{₀}) in the anonymous transaction request Q_{P}_{₀} through a signature verification function Ver(⋅).
(1) If Ver(Sign_{P}_{₀}, (tid_{P}_{₀}))=Sign_{P}_{₀}, (tid_{P}_{₀}), indicating that an identity of the user U_{R} passes the verification, the network user may determine whether to accept the request.
1) If the network user U_{P}_{₁}, accepts the anonymous transaction request of the user U_{P}_{₀}, the network user calls AnsReq(⋅) to generate a reply ciphertext R_{P}_{₁} as follows:

$$Ans Re q ( {tid}_{{p}_{0}} , {U}_{{p}_{j}} , {add}_{{P}_{j}} , {PK}_{{P}_{0}} , {SK}_{{P}_{j}} ) ⇒ \{ \begin{matrix}Signature {( {tid}_{{P}_{0}} ‖ {U}_{{P}_{j}} ‖ {add}_{{P}_{j}} )}_{{SK}_{{P}_{j}}} \to {Sign}_{{P}_{j}} ( {tid}_{{P}_{0}} ‖ {U}_{{P}_{j}} ‖ {add}_{{P}_{j}} ) \\ Encrypt {( {U}_{{P}_{j}} , {add}_{{P}_{j}} , {Sign}_{{P}_{j}} ( {tid}_{{P}_{0}} ‖ {U}_{{P}_{j}} ‖ {add}_{{P}_{j}} ) )}_{{PK}_{{P}_{0}}} \to {R}_{{P}_{j}}\end{matrix} \} ⇒ {R}_{{P}_{j}} ;$$

and sends the ciphertext R_{P}_{ⱼ}={U_{P}_{ⱼ}, add_{P}_{ⱼ}, Sign_{P}_{ⱼ}(tid_{P}_{₀}∥U_{P}_{ⱼ}∥add_{P}_{ⱼ})}_{P}_{₀} to the user U_{P}_{₀} through the message platform MB. add_{P}_{ⱼ} is an account address of the network user U_{P}_{ⱼ}. PK_{P}_{₀} is a public key of the user U_{P}_{₀}. SK_{P}_{ⱼ} is a private key of the user U_{P}_{ⱼ}. Encrypt(⋅) is encrypting information through elliptic curve cryptography (ECC).
2) If the network user U_{P}_{ⱼ}, rejects the anonymous transaction request of the user U_{P}_{₀}, the network user does not respond.
(2) If Ver(Sign_{P}_{₀}(tid_{P}_{₀}))≠Sign_{P}_{₀}(tid_{P}_{₀}), indicating that an identity of the user U_{P}_{₀} fails the verification, the network user may directly reject the request.
Step 3: After receiving the reply ciphertext R_{P}_{ⱼ}={U_{P}_{ⱼ}, add_{P}_{ⱼ}, Sign_{P}_{ⱼ}(tid_{P}_{₀}∥U_{P}_{ⱼ}∥add_{P}_{ⱼ})}_{P}_{₀} from the network user U_{P}_{ⱼ}, the user U_{P}_{₀} decrypts the reply ciphertext by using the private key SK_{P}_{₀} of the user, and verifies correctness of the signature information Sign_{P}_{ⱼ}(tid_{P}_{₀}∥U_{P}_{ⱼ}∥add_{P}_{ⱼ}) in the reply ciphertext R_{P}_{ⱼ}.
(1) If Ver(Sign_{P}_{ⱼ}(tid_{P}_{₀}∥U_{P}_{ⱼ}∥add_{P}_{ⱼ}))=Sign_{P}_{ⱼ}(tid_{P}_{₀}∥U_{P}_{ⱼ}∥add_{P}_{ⱼ}), indicating that an identity of the network user passes the verification, the user may add the network user U_{P}_{ⱼ} to the anonymous set M_{Set} as a transaction mixer.
(2) If Ver(Sign_{P}_{ⱼ}(tid_{P}_{₀}∥U_{P}_{ⱼ}∥add_{P}_{ⱼ})≠Sign_{P}_{ⱼ}(tid_{P}_{₀}∥U_{P}_{ⱼ}∥add_{P}_{ⱼ}), indicating that an identity of the network user fails the verification, the user refuses to add the network user to the anonymous set M_{Set}.
Step 4: If a quantity of transaction mixers in the anonymous set M_{Set} does not meet the privacy requirement k of the user U_{P}_{₀}, the user continues to wait for the network users to respond. If the privacy requirement k of the user U_{P}_{₀} is met, the user randomly selects k users to form the final anonymous set M_{Set} and enters a transaction execution phase.

After entering the transaction execution phase, the user U_{P}_{₀} randomly allocates the sub-transaction

$${t}_{i} ( {{M}_{i} \to {M}_{i + 1}}^{m} )$$

for which each transaction mixer Mᵢ in the anonymous set M_{Set} is responsible; calls a tag generation function TagGen(⋅) to generate the tag tag marking the key transaction mixer Mₖ as follows:

$$TagGen ( {tid}_{{P}_{0}} , {U}_{{P}_{0}} , {M}_{k} , {PK}_{S} ) ⇒ \{ \begin{matrix}Encrypt {( {U}_{{P}_{0}} , {M}_{k} )}_{{PK}_{S}} \to tag \\ Ctr ( tag , {tid}_{{P}_{0}} )\end{matrix} \} ⇒ {tag}^{{tid}_{{P}_{0}}} ;$$

and sends the tag

$${tag}^{{tid}_{{P}_{0}}}$$

to the message platform MB for storage. After receiving the tag

$${tag}^{{tid}_{{P}_{0}}} ,$$

the message platform MB updates an information table

$${B}_{2} ( Send ↦ {U}_{{P}_{0}} Tag ↦ {tag}^{{tid}_{{P}_{0}}} ) .$$

Step 5: The user U_{P}_{₀} calls NewWork(⋅) to generate the task ciphertext

$${W}_{{P}_{0}}^{{M}_{i}}$$

to be sent to the transaction mixer Mᵢ:

$$NewWork ( m , {add}_{{M}_{i + 1}} , {PK}_{{M}_{i}} , {SK}_{{P}_{0}} ) ⇒ \{ \begin{matrix}Signature {( m ‖ {add}_{{M}_{i + 1}} )}_{{SK}_{{P}_{0}}} \to {Sign}_{{P}_{0}} ( m ‖ {add}_{{M}_{i + 1}} ) \\ Encrypt {( m , {add}_{{P}_{j}} , {Sign}_{{P}_{0}} ( m ‖ {add}_{{M}_{i + 1}} ) )}_{{PK}_{{M}_{i}}} \to {W}_{{P}_{0}}^{{M}_{i}} \\ Ctr ( {W}_{{P}_{0}}^{{M}_{i}} , {tid}_{{P}_{0}} )\end{matrix} \} ⇒ {{W}_{{P}_{0}}^{{M}_{i}}}^{{tid}_{{P}_{0}}} .$$

At this time, the message platform MB stores the task ciphertext

$${{W}_{{P}_{0}}^{{M}_{i}}}^{{tid}_{{P}_{0}}} = {\{ m , {add}_{{M}_{i + 1}} , {Sign}_{{P}_{0}} ( m ‖ {add}_{{M}_{i + 1}} ) \}}_{{M}_{i}}$$

and updates an information table

$${B}_{3} ( Send ↦ {U}_{{P}_{0}} Receive ↦ {M}_{i} Message ↦ {{W}_{{P}_{0}}^{{M}_{i}}}^{{tid}_{{P}_{0}}} ) . {W}_{{P}_{0}}^{{M}_{i}}$$

is the task ciphertext obtained by using the public key of the user Mᵢ to encrypt information. add_{M}_{ᵢ₊₁} is an account address of the target user Mᵢ₊₁ corresponding to the sub-transaction

$${t}_{i} ( {{M}_{i} \to {M}_{i + 1}}^{m} ) .$$

Step 6: After receiving the task ciphertext

$${{W}_{{P}_{0}}^{{M}_{i}}}^{{tid}_{{P}_{0}}} = {\{ m , {add}_{{M}_{i + 1}} , {Sign}_{{P}_{0}} ( m ‖ {add}_{{M}_{i + 1}} ) \}}_{{M}_{i}}$$

sent by the user U_{P}_{₀}, the transaction mixer Mᵢ decrypts the task ciphertext by using the private key SK_{M}_{ᵢ} and verifies the signature information Sign_{P}_{₀}(m∥add_{M}_{ᵢ₊₁}) of the user U_{P}_{₀} in the task ciphertext

$${W}_{{P}_{0}}^{{M}_{i}}$$

(1) If Ver(Sign_{P}_{₀}(m∥add_{M}_{ᵢ₊₁})=Sign_{P}_{₀}(m∥add_{M}_{ᵢ₊₁}), indicating that the identity information of the user U_{P}_{₀} passes the verification, the transaction mixer Mᵢ executes the sub-transaction

$${t}_{i} ( {{M}_{i} \to {M}_{i + 1}}^{m} )$$

based on the task content.
(2) If Ver(Sign_{P}_{₀}(m∥add_{M}_{ᵢ₊₁}))≠Sign_{P}_{₀}(m∥add_{M}_{ᵢ₊₁})), indicating that the identity information of the user U_{P}_{₀} is forged, the transaction mixer Mᵢ refuses to execute the task.

Execution of the actual transaction

$$T ( {U}_{{P}_{0}} {\to }^{m} {U}_{{R}_{1}} )$$

of the user U_{P}_{₀} is completed only after all transaction mixers Mᵢ in the anonymous set execute the sub-transaction

$${t}_{i} ( {M}_{i} {\to }^{m} {M}_{i + 1} ) .$$

That is, ∀Mᵢ∈M_{Set}, Mᵢ has executed

$${t}_{i} ( {M}_{i} {\to }^{m} {M}_{i + 1} ) ⇔ T ( {U}_{{P}_{0}} {\to }^{m} {U}_{{R}_{1}} )$$

is completed.

In S104, the anonymous-transaction conditional tracing scheme CTS provides two different tracing schemes: a transaction tracing scheme and a fund tracing scheme.

The transaction tracing scheme allows the supervisor S to obtain identity information of an actual initiator and an actual recipient of any transaction to trace a single transaction. The fund tracing scheme allows the supervisor S to de-anonymize all anonymous transactions initiated by a target user, to determine a fund transfer path of the target user. These two schemes can help the supervisor trace anonymous transactions under conditions of grasping different information, and control a tracing scope within a scope required for law enforcement to protect transaction privacy of legitimate users.

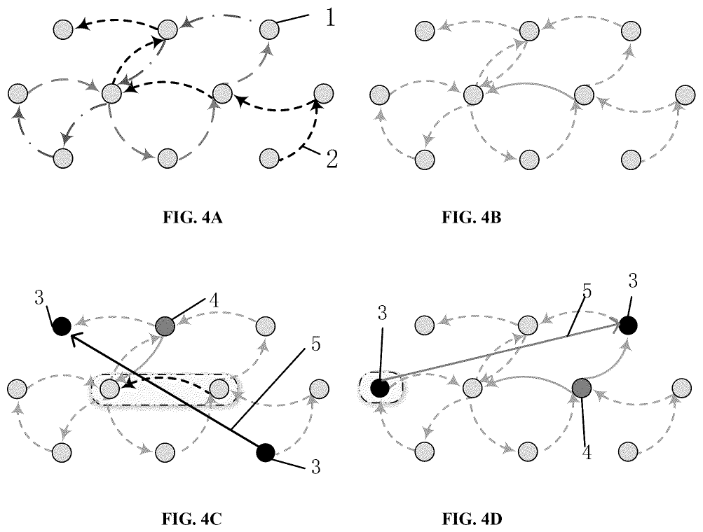

The anonymous-transaction conditional tracing scheme CTS may be simply formalized as an algorithmic sextuple: CTS={New Req(⋅), Ans Req(⋅), TagGen(⋅), NewWork(⋅), Tra-Trace(⋅), FundTrace(⋅)}. The first four functions are called in the anonymous transaction process, and the last two functions are used when the supervisor performs auditing. NewReq(⋅) is called when a user sends an anonymous transaction request. Ans Req(⋅) is called when a user responds to the request. When the transaction initiator calls NewReq(⋅) to generate an anonymous transaction request, a unique identifier tid corresponding to the anonymous transaction is generated. The identifier is used to mark the tag tag of the key transaction mixer Mₖ and the task ciphertext W_{P}_{₀}^{M}^{ᵢ} that are subsequently generated. TagGen(⋅) is used to generate the tag tag marking the key transaction mixer MR. NewWork(⋅) is used when the transaction initiator issues an anonymous transaction task. The supervisor S calls Tra-Trace(⋅) to trace a target transaction and FundTrace(⋅) to trace funds of a target user. FIGS. 4A-4D show a sample anonymous transaction and supervisor views of different supervision schemes.

The anonymous-transaction conditional tracing scheme CTS is based on a principle of threshold secret sharing. The information required to reconstruct the real transaction

$$T ( {U}_{{P}_{0}} {\to }^{m} {U}_{{R}_{1}} )$$

is distributed to a group of users C={S, M₁, . . . , Mᵢ, . . . , Mₖ}. To trace the transaction, the supervisor S needs the private key SK_{M}_{ₖ} of the key transaction mixer Mₖ in addition to the private key SKₛ of the supervisor and the information tables {B₁,B₂,B₃} stored and maintained by the message platform MB. This prevents unrestricted full-range supervision of the supervisor S and protects transaction privacy of legitimate users.

The supervisor S can use the transaction tracing scheme to determine identity information of an actual initiator and an actual recipient of the target transaction to trace a single transaction.
Step 1: When the supervisor S knows a specific amount m of a target transaction

$$t ( {u}_{1} {\to }^{m} {u}_{2} )$$

selects the recipient u₁ as a target investigation object, and filters the information table B₃(Send Receive Message) maintained by the message platform MB, to obtain all task ciphertexts W_{Set}={W_{U}_{₀}^{u}^{₁}, W_{U}_{₁}^{u}^{₁}, . . . , W_{U}_{ₙ}^{u}^{₁}} received by the user u₁.
Step 2: (1) If a quantity Count(W_{Set}) of the obtained task ciphertexts is greater than 0:
1) All anonymous transaction identifiers Tid={tid_{U}_{₀}, tid_{U}_{₁}, . . . , tid_{U}_{ₙ}} with which the task ciphertexts

$${W}_{S e t} = \{ {W}_{{U}_{0}}^{{u}_{1}} , {W}_{{U}_{1}}^{{u}_{1}} , … , {W}_{{U}_{n}}^{{u}_{1}} \}$$

are marked are found. Then, the supervisor S decrypts the anonymous transaction identifiers one by one by using the private key SKₛ of the supervisor, and performs preliminary filtering to obtain the anonymous transaction identifiers Tid′={tid_{U}_{₁}, tid_{U}_{ᵢ₊₁}, . . . , tid_{U}_{ᵢ₊ₓ}} with a same amount m as the target transaction

$$t ( {u}_{1} {\to }^{m} {u}_{2} )$$

and a timestamp tmp before the target transaction occurs, where x∈N⁺ and 0≤i≤n−x.
2) The task ciphertexts

$${W}_{Set}^{′} = \{ {W}_{{U}_{1}}^{{u}_{1}} , {W}_{{U}_{i + 1}}^{{u}_{1}} , … , {W}_{{U}_{i + x}}^{{u}_{1}} \}$$

marked with the anonymous transaction identifiers Tid′={tid_{U}_{₁}, tid_{U}_{ᵢ₊₁}, . . . , tid_{U}_{ᵢ₊ₓ}} are retained and decrypted one by one by using an obtained private key SKᵤ_{₁} of the user u₁, and the task ciphertext

$${W}_{{U}_{j}}^{{u}_{1}}$$

matching the current transaction information

$$t ( {u}_{1} {\to }^{m} {u}_{2} )$$

is finally found.
3) An anonymous transaction identifier tid_{U}_{ⱼ}, with which the task ciphertext

$${W}_{{U}_{j}}^{{u}_{1}}$$

is marked and a tag tag_{U}_{ⱼ} of a key transaction mixer Mₖ marked with the identifier are found. The anonymous transaction identifier tid_{U}_{ⱼ} and the tag tag_{U}_{ⱼ} are decrypted by using the private key SKₛ of the supervisor, to obtain the actual transaction amount m corresponding to the target transaction

$$t ( {u}_{1} {\to }^{m} {u}_{2} )$$

and the identity information of the actual transaction initiator U_{P} and the key transaction mixer Mₖ.
4) After obtaining the identity information of the key transaction mixer Mₖ, the supervisor S may filter the information table B₃(Send Receive Message) to obtain a task ciphertext

$${W}_{{U}_{j}}^{{M}_{k}}$$

received by the user Mₖ and marked with the anonymous transaction identifier tid_{U}_{ⱼ}, and then obtains a private key SK_{M}_{ₖ} of the key transaction mixer Mₖ to decrypt the task ciphertext

$${W}_{{U}_{j}}^{{M}_{k}} ,$$

to obtain the identity information of the actual transaction recipient U_{R}. Finally, the actual transaction

$$T ( {U}_{P} {\to }^{m} {U}_{R} )$$

is output.
(2) If a quantity Count(W_{Set}) of the obtained task ciphertexts is equal to 0, the user u₁ is the actual transaction initiator U_{P} and the user u₂ is the transaction mixer M₁. In this case, the supervisor S only needs to obtain the identity information of the actual transaction recipient U_{R} to de-anonymize the target transaction.
1) The supervisor S takes the user u₁ as a target user to carry out an investigation, filters the information table B₁(Send Tid) to obtain anonymous transaction identifiers Tid={tidᵤ_{₁}⁰, tidᵤ_{₁}¹, . . . , tidᵤ_{₁}ⁿ} corresponding to all anonymous transactions initiated by the user u₁, decrypts the anonymous transaction identifiers Tid={tidᵤ_{₁}⁰, tidᵤ_{₁}¹, . . . , tidᵤ_{₁}ⁿ} one by one by using the private key of the supervisor, and performs preliminary filtering to obtain the anonymous transaction identifiers Tid′={tidᵤ_{₁}ⁱ, tidᵤ_{₁}ⁱ⁺¹, . . . , tidᵤ_{₁}^{i+x}} with a same amount m as the target transaction

$$t ( {{u}_{1} \to {u}_{2}}^{m} )$$

and a timestamp tmp before the target transaction occurs, where x∈N⁺ and 0≤i≤n−x.
2) The supervisor finds a task ciphertext Wᵤ_{₁}^{u}^{₂} received by the user u₂ and marked with the anonymous transaction identifier Tid={tidᵤ_{₁}ⁱ, tidᵤ_{₁}ⁱ⁺¹, . . . , tidᵤ_{₁}^{i+x}} from the information table B₃(Send Receive Message).
3) The supervisor S finds a tag tagᵤ_{₁}ⁱ marked with an anonymous transaction identifier tidᵤ_{₁}ⁱ corresponding to the task ciphertext

$${W}_{{u}_{1}}^{{u}_{2}}$$

from the information table B₂(Send Tag), and decrypts the tag tagᵤ_{₁}ⁱ by using the private key SKₛ of the supervisor, to obtain the identity information of the key transaction mixer Mₖ.
4) The supervisor filters the information table B₃(Send Receive Message) to obtain a task ciphertext

$${W}_{{u}_{1}}^{{M}_{k}}$$

received by the key transaction mixer Mₖ and marked with the anonymous transaction identifier tidᵤ_{₁}ⁱ, and decrypts the task ciphertext

$${W}_{{u}_{1}}^{{M}_{k}}$$

by using the key of the key transaction mixer Mₖ, to obtain the identity information of the actual transaction recipient U_{R}. Finally, the actual transaction

$$T ( {{U}_{P} \to {U}_{R}}^{m} )$$

is output.

The supervisor S can use the fund tracing scheme to trace a flow of funds of a target user and de-anonymize all anonymous transactions with the target user as an actual transaction initiator, to determine a destination of the funds of the target user. A specific execution process of the fund tracing scheme is as follows:
Step 1: When the supervisor S needs to investigate a fund transfer path of a target user U_{B}, the supervisor first filters the information table B₁(Send Tid) maintained by the message platform MB, to obtain anonymous transaction identifiers Tid={tid_{B}⁰, tid_{B}¹, . . . , tid_{B}^{m}} corresponding to all anonymous transactions initiated by the target user U_{B}, and then decrypts the anonymous transaction identifiers Tid={tid_{B}⁰, tid_{B}¹, . . . , tid_{B}ⁿ} one by one by using the private key SKₛ of the supervisor, to obtain a specific amount m_{Set}={m₀, m₁, . . . , mₙ} of each transaction.
Step 2: The supervisor S finds, from the information table B₂(Send Tag) maintained by the message platform MB, tags Tag={tag_{B}⁰, tag_{B}¹, . . . , tag_{B}ⁿ} of key transaction mixers marked with the anonymous transaction identifiers Tid={tid_{B}⁰, tid_{B}¹, . . . , tid_{B}^{m}}. Then, the supervisor S decrypts the tags Tag={tag_{B}⁰, tag_{B}¹, . . . , tag_{B}ⁿ} by using the private key SKₛ of the supervisor, to obtain the key transaction mixer Mₖ={Mₖ⁰, Mₖ¹, . . . , Mₖⁿ} corresponding to each anonymous transaction.
Step 3: The supervisor S filters the information table B₃(Send Receive Message) to obtain a task ciphertext W_{B}^{M}^{ₖ}^{ⁱ} received by each key transaction mixer Mₖⁱ in the set Mₖ={Mₖ⁰, Mₖ¹, . . . , Mₖⁿ} and marked with the anonymous transaction identifier tidⁱ_{B}, to finally obtain a task ciphertext set W_{Set}={W_{B}^{M}^{ₖ}^{⁰}, W_{B}^{M}^{ₖ}^{¹}, . . . , W_{B}^{M}^{ₖ}^{ⁿ}}
Step 4: The supervisor S obtains a private key of each key transaction mixer Mₖⁱ in the set Mₖ={Mₖ⁰, Mₖ¹, . . . , Mₖⁿ}, and decrypts the task ciphertext W_{B}^{M}^{ₖ}^{ⁱ} one by one to obtain identity information of an actual transaction recipient U_{Set}={U_{R}⁰, U_{R}¹, . . . , U_{R}ⁿ} corresponding to each anonymous transaction.
Step 5: A transaction set

$${T}_{Set} = \{ {T}_{0} ( {{U}_{B} \to {U}_{R}^{0}}^{{m}_{0}} ) , {T}_{1} ( {{U}_{B} \to {U}_{R}^{1}}^{{m}_{1}} ) , ⋯ , {T}_{n} ( {{U}_{B} \to {U}_{R}^{n}}^{{m}_{n}} ) \}$$

of funds transferred out of the target user U_{B} is finally output based on the specific amount m_{Set}={m₀, m₁, . . . , mₙ} of each anonymous transaction initiated by the target user U_{B} and the identity information of the actual transaction recipient U_{Set}={U_{R}⁰, U_{R}¹, . . . , U_{R}ⁿ} corresponding to each anonymous transaction.

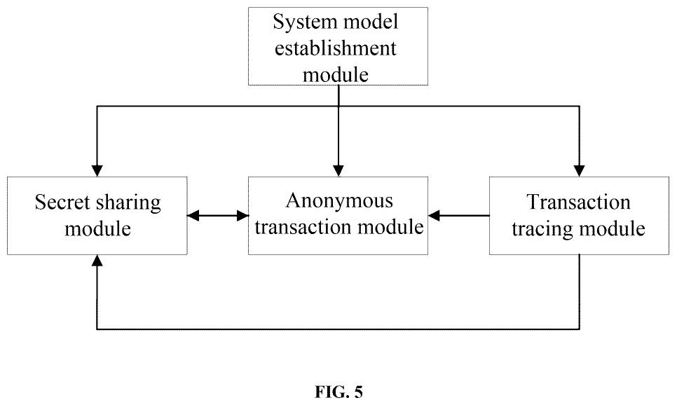

As shown in FIG. 5, a system for conditionally tracing an anonymous transaction based on secret sharing includes the following modules:
a system model establishment module configured to introduce a message platform and a supervisor to design a system model;
a secret sharing module connected to the system model establishment module, an anonymous transaction module, and a transaction tracing module, and configured to reconstruct information about a real transaction of a user to enhance privacy of an ordinary user and reduce secret reconstruction difficulty for the supervisor;
the anonymous transaction module connected to the system model establishment module, the secret sharing module, and the transaction tracing module, and configured to conduct an anonymous transaction between a transaction initiator and a transaction recipient; and
the transaction tracing module connected to the system model establishment module, the secret sharing module, and the anonymous transaction module, and configured to trace an anonymous transaction, including transaction tracing and fund tracing.

The method for conditionally tracing an anonymous transaction based on secret sharing provided in the application embodiments of the present disclosure is applied to a computer device. The computer device includes a memory and a processor. The memory stores a computer program. The computer program, when executed by the processor, enables the processor to perform steps of the method for conditionally tracing an anonymous transaction based on secret sharing.

The method for conditionally tracing an anonymous transaction based on secret sharing provided in the application embodiments of the present disclosure is applied to an information data processing terminal. The information data processing terminal is configured to implement the system for conditionally tracing an anonymous transaction based on secret sharing.

A blockchain technology has been widely used in the financial field because its unique characteristics such as multiparty consensus, traceability, and data encryption are highly coupled with business characteristics of the financial field. At present, development of the blockchain technology in China has gradually risen to a national strategic level. However, global disclosure of transaction information of a blockchain makes privacy security of the blockchain seriously questioned. Revelation of pseudo-anonymity of a blockchain makes an anonymous transaction idea widely studied and applied in academia. People's increasing sensitivity to transaction information also makes an anonymous transaction technology gradually applied in real life. However, most of existing anonymous transaction schemes strive to pursue transaction anonymity, ignoring work difficulty brought by strong anonymity to regulatory authorities. Unsupervised transactions provide opportunities for lawbreakers, threatening social harmony and stability. However, excessively strong transaction traceability increases work pressure of the regulatory authorities and violates transaction privacy of legitimate users. Therefore, the existing schemes cannot balance transaction anonymity and transaction traceability. Through the method and system for conditionally tracing an anonymous transaction based on secret sharing in the present disclosure, transaction anonymity can be maintained, and the regulatory authorities can trace anonymous transactions under conditions of grasping different information, and control a tracing scope within a scope required for law enforcement to protect privacy safety of legitimate users. Therefore, in the present disclosure, anonymous transactions can be de-anonymized while transaction anonymity is maintained. A transaction anonymity requirement of users and a regulatory auditing requirement of the regulatory authorities both can be met.
Theorem 1: If an elliptic curve discrete logarithm problem on which the ECDSA and ECC used in the scheme CTS are based is difficult and the anonymous set M_{Set} is covertly generated, the present disclosure satisfies transaction anonymity.
Proof: That the anonymous set M_{Set} is covertly generated means that only the transaction initiator U_{P} knows the transaction mixers contained in the anonymous set M_{Set} and a link in which each transaction mixer Mᵢ, is located in the anonymous transaction. In addition, the present disclosure assumes that all transaction mixers in the anonymous set M_{Set} are trusted internal collaborators. That is, they do not actively disclose anonymous transaction information that they have. A malicious external attacker launches a Sybil attack to forge user identities, to obtain anonymous transaction information. Specifically, the attacker joins the anonymous set through identity disguise, multi-identity, or a replay attack to obtain the anonymous transaction information, and destroys transaction anonymity based on the information. In addition to joining the anonymous set to obtain the anonymous transaction information, the attacker directly attacks the message platform MB, and obtains and deciphers ciphertext information stored on the platform, to destroy transaction anonymity. Therefore, an adversary of transaction anonymity is A_{adv}∈{A_{syb}, A_{dbc}}. A_{syb} is an adversary launching the Sybil attack. A_{dbc} is an adversary launching a database attack and ciphertext attack. When the adversaries A_{syb} and A_{dbc} successfully attack any game, Adv can successfully attack transaction anonymity of the present disclosure with a specific probability.
Game1: Based on anonymous transaction steps of the scheme CTS, a process in which the adversary A_{syb} simulates the Sybil attack is as follows.
Step1: In a generation phase, after receiving the anonymous transaction request Q_{P}={tid_{P}, Sign_{P} (tid_{P})} broadcast by the target transaction initiator U_{P}, the adversary A_{syb} launches the Sybil attack to forge a plurality of user identities A_{A}_{_{syb}}={P_{A}_{_{syb}}⁰, P_{A}_{_{syb}}¹, . . . , P_{A}_{_{syb}}^{q}}, calls the function Ans Req(⋅) to generate a plurality of request replies R_{A}_{_{syb}}ⁱ={U_{A}_{_{syb}}ⁱ, add_{A}_{_{syb}}ⁱ, Sign_{A}_{_{syb}}ⁱ (tid_{P}∥U_{A}_{_{syb}}ⁱ∥add_{A}_{_{syb}}ⁱ)} to be sent to the target transaction initiator U_{P}, and encrypts reply content by using the public key PK_{U}_{ₚ} of the target transaction initiator U_{P} to obtain reply ciphertexts. The Sybil attack may be launched to forge the plurality of user identities through identity disguise, multi-identity, a replay attack, or the like. Identity disguise means that the adversary A_{syb} forges digital signatures of other users to pass identity verification of the target transaction initiator U_{P}. Multi-identity means that the adversary A_{syb} registers a plurality of user identities on the message platform MB. The replay attack means that the adversary A_{syb} intercepts valid request replies sent by the other users and resends the replies to the target transaction initiator U_{P}.
Step2: In a challenge phase, the adversary A_{syb}, sends the generated false replies R_{A}_{_{syb}}ⁱ to the target transaction initiator U_{P} in expectation of joining the anonymous set M_{Set} of the target transaction initiator U_{P}.
Step3: In a guess phase, it is assumed that ξ_{λ} is a negligible probability and a quantity of the false replies R_{A}_{_{syb}}ⁱ generated by the adversary A_{syb} is q(q≥k). It can be learned based on the anonymous set generation manner that a success rate of identity verification greatly affects a probability that the adversary A_{syb} successfully joins the anonymous set M_{Set} of the target transaction initiator U_{P}. If the adversary A_{syb} forges a digital signature of another user through identity disguise, a probability that the signature passes identity verification is extremely low because a signature algorithm used in the scheme CTS is ECDSA and the elliptic curve discrete logarithm problem on which the algorithm is based is difficult. In addition, an identity authentication function of the message platform MB does not allow the adversary A_{syb} to register a plurality of user identities. If the adversary A_{syb} replays the valid request replies sent by the other users, it is almost impossible for the adversary A_{syb} to join the anonymous set by replaying the valid replies from others because a digital signature Sign (tid∥⋅)⋅ of the request reply contains an identifier tid of the anonymous transaction corresponding to the request reply. It can be learned that a probability that the adversary A_{syb} successfully passes the identity verification of the target transaction initiator U_{P} is ξ_{λ}.

The privacy requirement k of the target transaction initiator U_{P} and a quantity c of users in the network who reply to the anonymous transaction request also affect the probability that the adversary A_{syb} successfully joins the anonymous set M_{Set} of the target transaction initiator U_{P}. That is, when the privacy requirement k of the target transaction initiator U_{P} is larger, the quantity c of users in the network who reply to the anonymous transaction request is smaller, the quantity q of the false replies R_{A}_{_{syb}}ⁱ generated by the adversary A_{syb} is larger, and the probability that the adversary successfully joins the anonymous set is higher. It can be calculated that a probability that the adversary A_{syb} can forge at least one user identity to successfully join the anonymous set M_{Set} of the target transaction initiator U_{P} is

$$Pr [ {A}_{syb} ⋂ {M}_{Set} \neq ∅ ] = \{ \begin{matrix}( 1 - \frac{{C}_{c}^{k}}{{C}_{q + c}^{k}} ) * {ξ}_{λ} < * {ξ}_{λ} & c \geq k \\ 1 * {ξ}_{λ} & c < k\end{matrix}$$

and a probability that the adversary A_{syb} can forge k user identities to successfully join the anonymous set M_{Set} of the target transaction initiator U_{P} is

$$Pr [ {A}_{syb} ⊃ {M}_{Set} ] = \frac{{C}_{q}^{k}}{{C}_{q + c}^{k}} * {ξ}_{λ} < {ξ}_{λ} .$$

It can be learned that the probability that the adversary A_{syb} launches the Sybil attack to join the anonymous set M_{Set} of the target transaction initiator U_{P} is negligible. Therefore, the adversary A_{syb} cannot obtain the anonymous transaction information by joining the anonymous set.
Game2: Based on a storage characteristic of the message platform MB, a process in which the adversary A_{dbc} simulates the database attack and ciphertext attack is as follows.
Step1: In a generation phase, the adversary A_{dbc} first launches the database attack to obtain an anonymous transaction identifier tid, a tag tag, and a task ciphertext W stored on the message platform MB, and the information tables B₁(Send Tid), B₂(Send Tag), and B₃(Send Receive Message) maintained by the message platform MB. The database attack of the adversary A_{dbc} is assumed to be maximized. That is, the adversary A_{dbc} can successfully obtain all ciphertext information stored on the message platform MB. After obtaining the ciphertext information, the adversary A_{dbc} forges keys needed to decrypt the anonymous transaction identifier tid, tag tag, task ciphertext W, and information tables {B₁, B₂, B₃}, that is, forges the private keys of the supervisor S, message platform MB, and corresponding user.
Step2: In a challenge phase, the adversary A_{dbc} decrypts the ciphertext information tid, tag {B₁, B₂, B₃}, and W by using the forged private keys SK′_{S}, SK′_{MB}, and SK′_{P}, to obtain, plaintexts corresponding to the ciphertext information.
Step3: In a guess phase, accuracy of private key forgery greatly affects a probability that the adversary A_{dbc} successfully decrypts the ciphertext information to obtain the anonymous transaction identifier tid, tag tag, information tables {B₁, B₂, B₃}, and task information W. A probability that the adversary A_{dbc} can successfully forge a user's private key is extremely low because an encryption algorithm used in the scheme CTS is ECC and the elliptic curve discrete logarithm problem on which the algorithm is based is difficult. Therefore, a success rate of the adversary A_{dbc} to destroy transaction anonymity by launching the database attack and ciphertext attack is extremely low.

Based on a security assumption of the scheme CTS in the conclusion, a probability that the adversaries A_{syb} and A_{dbc} successfully attack the respective games is negligible. Therefore, the present disclosure satisfies transaction anonymity.
Theorem 2: Transaction traceability is satisfied when the supervisor S knows the specific transaction amount m of the target transaction

$$t ( {{u}_{1} \to {u}_{2}}^{m} )$$

and the identity information of the initiator u₁ and the recipient u₂.
Proof: A basic idea of the transaction tracing scheme in the scheme CTS is to find the anonymous transaction identifier tidᵢ matching the target transaction

$$t ( {{u}_{1} \to {u}_{2}}^{m} ) ,$$

then find the tag tagᵢ marked with the anonymous transaction identifier, decrypt the tag to obtain the identity information of the key transaction mixer Mₖ, perform filtering to obtain the task ciphertext

$${W}_{{u}_{1}}^{{M}_{k}}$$

received by the key transaction mixer Mₖ and marked with the anonymous transaction identifier, and decrypt the task ciphertext to obtain the identity information of the actual transaction initiator U_{P} and transaction recipient U_{R}, to finally trace the target transaction and obtain the information about the actual transaction

$$T ( {{U}_{P} \to {U}_{R}}^{m} ) .$$

Based on the transaction tracing process of the transaction tracing scheme, the first key step in determining tracing reliability is to find the anonymous transaction identifier tidᵢ matching the target transaction

$$t ( {{u}_{1} \to {u}_{2}}^{m} ) .$$

It can be learned from the tracing process that the transaction tracing scheme can obtain the unique anonymous transaction identifier matching the target transaction

$$t ( {{u}_{1} \to {u}_{2}}^{m} )$$

through three rounds of filtering. The second key step in determining tracing reliability is to perform decryption to obtain the identity information of the key transaction mixer Mₖ in the tag tagᵢ marked with the anonymous transaction identifier tidᵢ. However, authenticity of the identity information of the key transaction mixer Mₖ in the tag tagᵢ is questionable. To secretly transfer illegal funds, a malicious transaction initiator hides identity information of a real key transaction mixer Mₖ such that a finally generated tag tagᵢ is false. If the tag tag is false, the identity information of the actual transaction recipient cannot be directly obtained on the premise of obtaining task content marked by the tag tagᵢ. Consequently, the target transaction cannot be traced. Therefore, the present disclosure provides an alternative scheme for malicious behavior that the transaction initiator forges the identity information of the key transaction mixer Mₖ. If the tag tagᵢ is known to be false, the supervisor S can still restore the real transaction by finding all task ciphertexts marked with the transaction identifier tidᵢ corresponding to the false tag tagᵢ.
Theorem 3: Fund traceability is satisfied when the supervisor S has the identity information of the target user U_{B}.
Proof: A basic idea of the fund tracing scheme in the scheme CTS is to find the anonymous transactions initiated by the target user U_{B} and the corresponding anonymous transaction identifiers, and associate the anonymous transaction identifier with the key transaction mixer corresponding to each transaction, to obtain the actual recipient of each transaction and trace the funds of the target user U_{B}.

Based on the fund tracing process of the fund tracing scheme, the key to determining tracing reliability is the authenticity of the tag tag. It can be learned in combination with the analysis of theorem 3 that tracing the fund flow of the target user U_{B} by the supervisor S is not affected regardless of whether the tag tag is real, although supervision costs are affected.

It can be learned in combination with theorems 2 and 3 that the target transaction and the funds of the target user can be traced when the supervisor S grasps different premise information. Therefore, the present disclosure has traceability, and tracing results are highly reliable.

### Experimental Analysis:

In this experiment, an elliptic curve public key cryptographic algorithm SM2 issued by the State Cryptography Administration of China is used to encrypt and sign information in an anonymous transaction process. The Java programming language is used to implement the elliptic curve public key cryptographic algorithm SM2 and an anonymous transaction conditional tracing algorithm. An experimental environment is 11th Gen Intel® Core™ i5-1135G7 @2.40 GHz (8CPUs), ˜2.4 GHz 8192 MB RAM, and an operating system is Windows10-64 bit.

### Experimental Verification of Transaction Tracing:

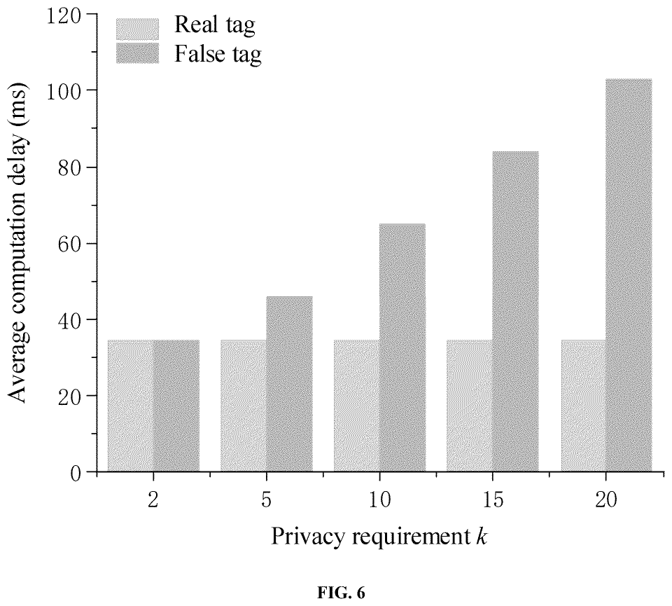

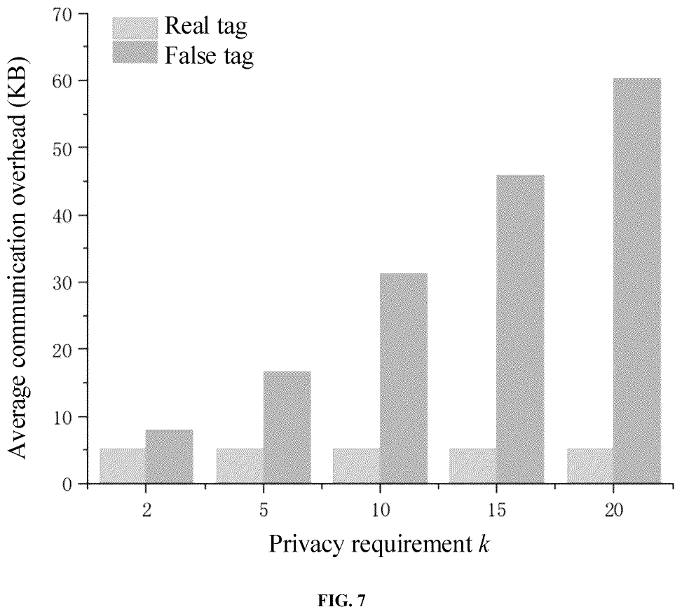

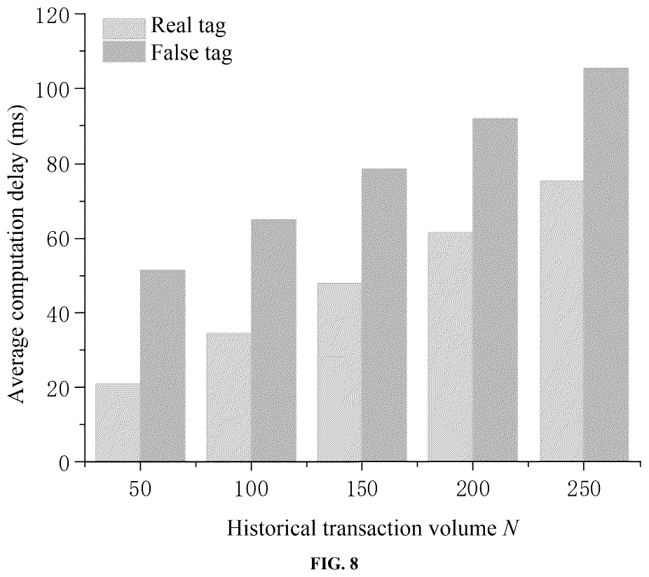

In this experiment, a historical transaction volume N=100 is first set. Then, a transaction tracing algorithm is repeatedly executed based on different privacy requirements k of a transaction initiator. Finally, an average computation delay and an average communication overhead required for transaction tracing when the transaction initiator provides a real tag or a false tag are obtained, as shown in FIG. 6 and FIG. 7.

When the transaction initiator provides the real tag, the average computation delay and the average communication overhead required for transaction tracing do not significantly change regardless of the privacy requirement k. However, when the transaction initiator provides the false tag, the average computation delay and the average communication overhead required for transaction tracing increase as the privacy requirement k increases. A reason for this phenomenon is that if a tag provided by the transaction initiator and marking a key transaction mixer Mₖ is real, a specific amount of a target transaction and identity information of the actual initiator and recipient of the target transaction can be obtained through an anonymous transaction identifier tid and ciphertext information owned by the key transaction mixer Mₖ, to trace the target transaction. However, if a tag provided by the transaction initiator is false, identity information of an actual transaction recipient cannot be obtained only by obtaining task information owned by a false key transaction mixer Mₖ. In this case, an identity of the actual transaction recipient can be correctly determined only by obtaining ciphertext information held by each transaction mixer in an anonymous set. It can be learned that when the transaction initiator provides the false tag, task ciphertexts of k transaction mixers in the anonymous set need to be obtained and decrypted to trace the transaction. Therefore, the average computation delay and the average communication overhead required for transaction tracing increase as the privacy requirement k of the transaction initiator increases.

It can be found from experimental data that average computation delays and average communication overheads required by a supervisor for transaction tracing when the transaction initiator provides the real tag and the false tag are limited. When k=20, if the tag is real, the average computation delay and the average communication overhead required for transaction tracing are respectively 34.553 ms and 5.279 KB; or if the tag is false, the average computation delay and the average communication overhead required for transaction tracing are respectively 103.011 ms and 60.447 KB.

### Impact of a Historical Transaction Volume on Transaction Tracing:

Impact of the historical transaction volume on an average computation delay and an average communication overhead required for transaction tracing is analyzed. In this experiment, a privacy requirement k=10 of a user in a network is first set. Then, a transaction tracing algorithm is repeatedly executed under conditions of different historical transaction volumes and real and false tags.

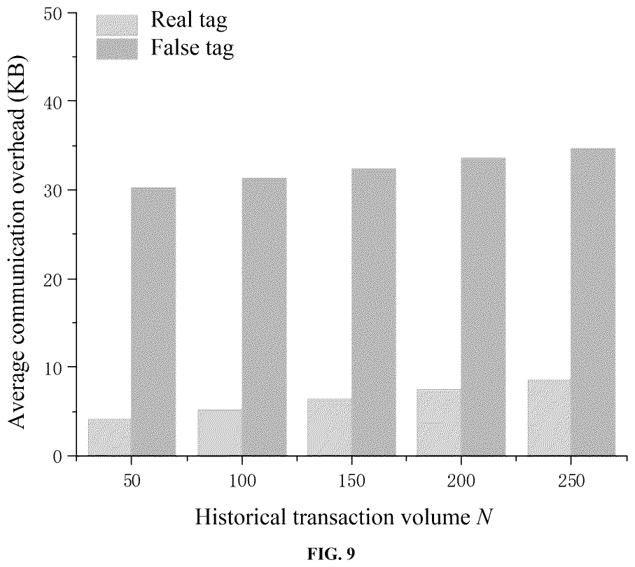

Experimental results are shown in FIG. 8 and FIG. 9. Regardless of whether a tag provided by a transaction initiator is real, the average computation delay and the average communication overhead required for transaction tracing increase as the historical transaction volume increases. When the historical transaction volume N increases from 50 to 250, the average computation delay required for transaction tracing increases from 20.821 ms to 75.199 ms if the tag is real, and increases from 51.43 ms to 105.554 ms if the tag is false; and the average communication overhead required for transaction tracing increases from 4.157 KB to 8.645 KB if the tag is real, and increases from 30.224 KB to 34.712 KB if the tag is false.

### Experimental Verification of Fund Tracing:

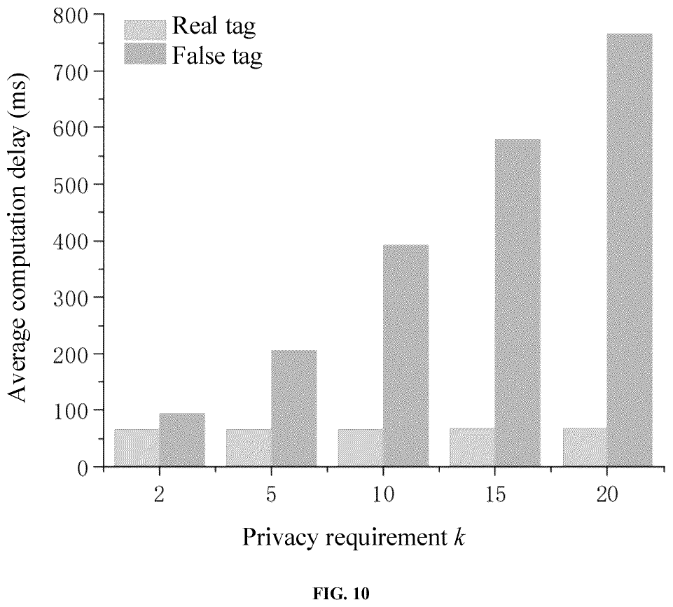

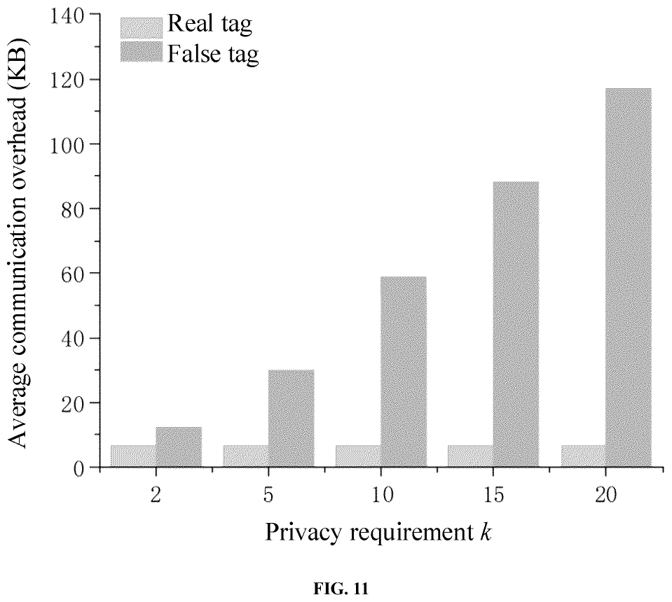

In this experiment, a historical transaction volume N=100 is first set. Then, a fund tracing algorithm is repeatedly executed based on different privacy requirements k of a transaction initiator. Finally, an average computation delay and an average communication overhead required for fund tracing when the transaction initiator provides a real tag or a false tag are obtained, as shown in FIG. 10 and FIG. 11.

When the transaction initiator provides the real tag, the average computation delay and the average communication overhead required for fund tracing do not change as the privacy requirement k changes. However, when the transaction initiator provides the false tag, the average computation delay and the average communication overhead required for fund tracing increase as the privacy requirement k increases. A reason for this phenomenon is that if a tag provided by the transaction initiator and marking a key transaction mixer Mₖ is real, a specific amount corresponding to an anonymous transaction initiated by a target user and identity information of an actual recipient can be obtained through an anonymous transaction identifier tid and ciphertext information owned by the key transaction mixer Mₖ, to trace funds of the target user. However, if a tag provided by the transaction initiator is false, identity information of an actual transaction recipient cannot be obtained only by obtaining ciphertext information owned by a false key transaction mixer Mₖ. In this case, an identity of the actual transaction recipient can be correctly determined only by obtaining task information held by each transaction mixer in an anonymous set selected by a target user. It can be learned that when the transaction initiator provides the false tag, task ciphertexts of k transaction mixers in the anonymous set need to be obtained and decrypted to trace the funds. Therefore, the average computation delay and the average communication overhead required for fund tracing increase as the privacy requirement k of the transaction initiator increases.

It can be found from experimental data that average computation delays and average communication overheads required by a supervisor for fund tracing when the transaction initiator provides the real tag and the false tag are limited. When k=20, if the tag is real, the average computation delay and the average communication overhead required for fund tracing are respectively 67.59 ms and 6.859 KB; or if the tag is false, the average computation delay and the average communication overhead required for fund tracing are respectively 767.42 ms and 117.195 KB.

### Impact of a Historical Transaction Volume on Fund Tracing:

Impact of the historical transaction volume on an average computation delay and an average communication overhead required for fund tracing is analyzed. In this experiment, a privacy requirement k=10 of a user in a network is first set. Then, a fund tracing algorithm is repeatedly executed under conditions of different historical transaction volumes and real and false tags.

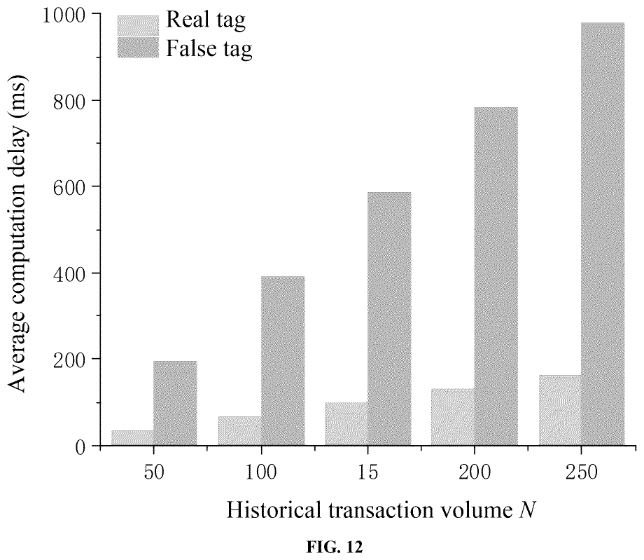

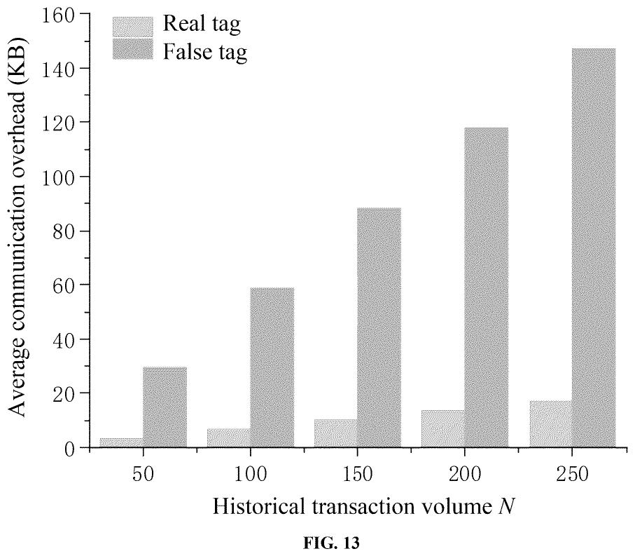

Experimental results are shown in FIG. 12 and FIG. 13. Regardless of whether a tag provided by a transaction initiator is real, the average computation delay and the average communication overhead required for fund tracing increase as the historical transaction volume increases. When the historical transaction volume N increases from 50 to 250, the average computation delay required for fund tracing increases from 34.616 ms to 164.394 ms if the tag is real, and increases from 196.524 ms to 980.136 ms if the tag is false; and the average communication overhead required for fund tracing increases from 3.429 KB to 17.148 KB if the tag is real, and increases from 29.496 KB to 147.48 KB if the tag is false.

### Experimental Conclusion:

To resolve a problem of difficult transaction tracing due to strong transaction anonymity and fill a gap of existing research, the scheme for conditionally tracing an anonymous transaction based on secret sharing is designed based on the decentralized coin mixing structure in the present disclosure. In the scheme, the system model for conditionally tracing an anonymous transaction is first designed. The information for reconstructing the real transaction of the user is divided based on the threshold secret sharing idea. The secret reconstruction difficulty for an ordinary user is increased to reduce the probability of collusion attacks and maintain transaction anonymity. The secret reconstruction difficulty for the supervisor is reduced. This can reduce supervision overheads while preventing unrestricted full-range supervision of the supervisor. The two tracing schemes provided for the supervisor in the present disclosure can help the supervisor trace anonymous transactions and funds under conditions of grasping different information. Both theoretical analysis and experimental results show that the present disclosure can give consideration to transaction anonymity and transaction traceability and strike a balance between a user privacy protection requirement and a government regulatory auditing requirement.

### Application Embodiment 1: Digital Currency Anonymous Transaction Platform

1. System construction: The method is implemented on a blockchain-based digital currency transaction platform. In S101, a message platform and a supervisor are introduced into the platform. The message platform acts as an intermediary and is responsible for processing and transmitting anonymous transaction information. The supervisor has permission to trace transactions, such as a financial supervisor.
2. Threshold secret sharing: In S102, when a user conducts a transaction, the message platform encrypts and divides transaction information through a threshold secret sharing scheme to protect privacy of the user. The supervisor can reconstruct and trace the transaction information by obtaining all secret fragments through collaboration only if a specific condition is met (such as a suspected illegal transaction).
3. Transaction process: In S103, user A wants to anonymously send digital currency to user B. The user A operates through the message platform. The message platform encrypts transaction information through the threshold secret sharing scheme and records a transaction on a blockchain.
4. Tracing operation: In S104, if the supervisor suspects that a transaction is suspected of illegal behavior, the supervisor can use the anonymous-transaction conditional tracing scheme to collaborate with the message platform to obtain secret fragments and trace the transaction.

### Application Embodiment 2: Electronic Voting System

1. System construction: The method is implemented in an electronic voting system. A voter can anonymously vote. However, a vote can be traced if needed, for example, when suspected cheating occurs. A message platform and a supervisor are introduced into the system. The message platform processes information about each vote. The supervisor, such as an election supervisor, has permission to trace votes under a specific condition.
2. Threshold secret sharing: In S102, when a voter votes, the message platform encrypts and divides vote information through a threshold secret sharing scheme. The supervisor can reconstruct the vote information only if a dispute arises.
3. Voting process: In S103, voters anonymously vote online. The message platform encrypts each vote through the threshold secret sharing scheme and records the vote in the system.
4. Tracing operation: In S104, if the supervisor needs to trace a vote for some reason (such as suspected cheating), the supervisor can use the anonymous-transaction conditional tracing scheme to collaborate with the message platform to obtain real information of the vote.

In both embodiments, the method can effectively protect user privacy while allowing supervisors to perform tracing under specific conditions to ensure fairness and transparency of the system.

The foregoing descriptions are merely descriptions of the specific embodiments of the present disclosure, and the protection scope of the present disclosure is not limited thereto. Any modification, equivalent replacement, improvement, and the like made within the technical scope of the present disclosure by those skilled in the art according to the spirit and principle of the present disclosure shall fall within the protection scope of the present disclosure.

What is claimed is:

1. A method for conditionally tracing an anonymous transaction based on secret sharing, comprising the following steps:
S101: introducing a message platform and a supervisor based on a typical decentralized coin mixing structure to design a system model for conditionally tracing an anonymous transaction;
S102: constructing a threshold secret sharing scheme based on a threshold secret sharing idea and dividing information required to reconstruct a real transaction of a user, to increase secret reconstruction difficulty for an ordinary user and reduce secret reconstruction difficulty for the supervisor;
S103: conducting an anonymous transaction between a transaction initiator and a transaction recipient; and
S104: tracing, by the supervisor, the anonymous transaction through an anonymous-transaction conditional tracing scheme CTS during auditing.

2. The method for conditionally tracing the anonymous transaction based on the secret sharing according to claim 1, wherein the message platform and the supervisor are introduced into the system model in S101.

3. The method for conditionally tracing the anonymous transaction based on the secret sharing according to claim 1, wherein the threshold secret sharing scheme in S102 comprises two phases: secret distribution and secret reconstruction.

4. The method for conditionally tracing the anonymous transaction based on the secret sharing according to claim 1, wherein in S102, each user is unique, and the message platform is allowed for verifying identity information of the user.

5. The method for conditionally tracing the anonymous transaction based on the secret sharing according to claim 1, wherein the anonymous-transaction conditional tracing scheme CTS provides two different tracing schemes: a transaction tracing scheme and a fund tracing scheme.

6. The method for conditionally tracing the anonymous transaction based on the secret sharing according to claim 5, wherein the transaction tracing scheme allows the supervisor to obtain identity information of an actual initiator and an actual recipient of any transaction to trace a single transaction; and the fund tracing scheme allows the supervisor to de-anonymize all anonymous transactions initiated by a target user, to determine a fund transfer path of the target user.

7. A system for conditionally tracing an anonymous transaction based on secret sharing, implementing the method for conditionally tracing the anonymous transaction based on the secret sharing according to claim 1 and comprising:
a system model establishment module configured to introduce the message platform and the supervisor to design the system model;
a secret sharing module connected to the system model establishment module, an anonymous transaction module, and a transaction tracing module, and configured to reconstruct information about the real transaction of the user to enhance privacy of the ordinary user and reduce the secret reconstruction difficulty for the supervisor;
the anonymous transaction module connected to the system model establishment module, the secret sharing module, and the transaction tracing module, and configured to conduct the anonymous transaction between the transaction initiator and the transaction recipient; and
the transaction tracing module connected to the system model establishment module, the secret sharing module, and the anonymous transaction module, and configured to trace the anonymous transaction, comprising transaction tracing and fund tracing.

8. A computer device, comprising a memory and a processor, wherein the memory stores a computer program, and the computer program, when executed by the processor, enables the processor to perform steps of the method for conditionally tracing the anonymous transaction based on the secret sharing according to claim 1.

9. A computer-readable storage medium, storing a computer program, wherein the computer program, when executed by a processor, enables the processor to perform steps of the method for conditionally tracing the anonymous transaction based on the secret sharing according to claim 1.

10. An information data processing terminal, wherein the information data processing terminal is configured to implement the system for conditionally tracing the anonymous transaction based on the secret sharing according to claim 7.

11. The system according to claim 7, wherein in the method, the message platform and the supervisor are introduced into the system model in S101.

12. The system according to claim 7, wherein in the method, the threshold secret sharing scheme in S102 comprises two phases: secret distribution and secret reconstruction.

13. The system according to claim 7, wherein in S102 of the method, each user is unique, and the message platform is allowed for verifying identity information of the user.

14. The system according to claim 7, wherein in the method, the anonymous-transaction conditional tracing scheme CTS provides two different tracing schemes: a transaction tracing scheme and a fund tracing scheme.

15. The system according to claim 14, wherein in the method, the transaction tracing scheme allows the supervisor to obtain identity information of an actual initiator and an actual recipient of any transaction to trace a single transaction; and the fund tracing scheme allows the supervisor to de-anonymize all anonymous transactions initiated by a target user, to determine a fund transfer path of the target user.

16. The computer device according to claim 8, wherein in the method, the message platform and the supervisor are introduced into the system model in S101.

17. The computer device according to claim 8, wherein in the method, the threshold secret sharing scheme in S102 comprises two phases: secret distribution and secret reconstruction.

18. The computer device according to claim 8, wherein in S102 of the method, each user is unique, and the message platform is allowed for verifying identity information of the user.

19. The computer device according to claim 8, wherein in the method, the anonymous-transaction conditional tracing scheme CTS provides two different tracing schemes: a transaction tracing scheme and a fund tracing scheme.

20. The computer device according to claim 19, wherein in the method, the transaction tracing scheme allows the supervisor to obtain identity information of an actual initiator and an actual recipient of any transaction to trace a single transaction; and the fund tracing scheme allows the supervisor to de-anonymize all anonymous transactions initiated by a target user, to determine a fund transfer path of the target user.
